(19) United States
(12) Patent Application Publication
(10) Pub. No.: US 2016/0097554 A1
(43) Pub. Date: Apr. 7, 2016

(54) SMARTPHONE-OPERATED WIRELESS HVAC ANEMOMETER DEVICE AND SYSTEM

(71) Applicant: Weatherflow, Inc., Scotts Valley, CA (US)

(72) Inventors: Daniel Lyons, Soquel, CA (US); Scott Madden, Hollywood, FL (US); David St. John, New Smyma Beach, FL (US); Derek Trauger, Deland, FL (US)

(21) Appl. No.: 14/818,897

(22) Filed: Aug. 5, 2015

Related U.S. Application Data
(60) Provisional application No. 62/059,327, filed on Oct. 3, 2014.

(51) Int. Cl. F24F 11/00; G01P 5/06

(52) U.S. Cl. CPC F24F 11/001; G01P 5/06; F24F 11/006; F24F 11/008; F24F 2011/0038; F24F 2011/0041; F24F 2011/0061

(57) ABSTRACT

A smartphone-operated wireless HVAC airflow anemometer device and system includes an anemometer device having an impeller assembly, an inductor and a controller. A magnet within the impeller assembly generates an oscillating current in the inductor which is proportional to the rotational rate of the impeller. A controller captures and transmits this information wirelessly to an airflow balancing application located on a smartphone device that includes a plurality of algorithms for calculating airflow information. An environmental sensor unit, and an electronic compass are also located within the wireless anemometer device.

### CROSS-REFERENCE TO RELATED APPLICATIONS

This application claims the benefit of U.S. Application Ser. No. 62/059,327 filed on Oct. 3, 2014, the contents of which are incorporated herein by reference.

### TECHNICAL FIELD

The present invention relates generally to airflow measurement devices, and more particularly to an anemometer device which can utilize the processing and communicative abilities of a smartphone to obtain, store and distribute accurate airflow readings.

### BACKGROUND

The statements in this section merely provide background information related to the present disclosure and may not constitute prior art.

Heating, Ventilating, and Air Conditioning (HVAC) systems are designed to create and maintain stable climate controlled environments with clean circulated air. As such, one of the main goals of any HVAC system is to achieve occupant comfort, while ensuring the system operating costs are as low as possible. One of the main factors in reaching this goal is to balance the air ducts for proper warm or cool air delivery, thereby ensuring the entire structure is maintained at a uniform temperature.

Airflow balancing is typically performed by qualified HVAC technicians who use specialized equipment to determine the airflow emanating from each supply duct and/or entering each return duct. Once obtained and recorded, this information can be utilized to adjust the output and/or input of each individual air duct, thereby resulting in an even distribution of air within the overall system.

Some of the key information needed to properly balance an HVAC system includes taking measurements of the air velocity, calculating the air volume, and accounting for the AK factor. In this field, air velocity (distance traveled per unit of time) is usually expressed in linear feet per minute (LFM) or meters per second (m/s). By multiplying air velocity by the cross section area of an air duct, you can determine the air volume flowing past a point in the duct per unit of time. Volume flow is measured in cubic feet per minute (CFM) or cubic meters per hour (M3/h). The AK factor is the amount of free space available for airflow when there is a grille in place. AK factors are typically provided by the manufacturer on the grille itself and can be provided in inches or percentage of obstructed free space.

There are many known commercially available anemometer devices which function to measure airflow. As such, these traditional devices are purpose-built, standalone equipment having dedicated onboard components such as a CPU/processor, memory, display screen, user keyboard and sensor(s), for example. In this regard, traditional anemometers are not multi-functional, and must be carried and utilized in conjunction with other such equipment by a technician.

In addition to the above, it is sometimes necessary to factor environmental conditions such as temperature, humidity and pressure, along with the airflow readings. Such information can allow a user to calculate additional data such as the dew point, wind chill, heat index, apparent temperature and more, for example. At the present time, no such system exists, and each of these readings must be performed individually utilizing a plurality of different instruments.

Accordingly, it would be beneficial to provide a small, inexpensive wireless anemometer device which can utilize the processing and communicative abilities of a smartphone to obtain, calculate, store and transmit airflow information pertaining to an HVAC system and/or environmental conditions.

### SUMMARY OF THE INVENTION

The present invention is directed to a smartphone-operated wireless HVAC anemometer device and system. One embodiment of the present invention can include an anemometer device having an impeller assembly, an inductor and a controller. A magnet in the hub of the impeller assembly generates an oscillating current to the inductor, the frequency of which is directly proportional to the rotational rate of the impeller. The controller captures and transmits this information wirelessly.

The system also includes an airflow balancing application which can be downloaded onto a smartphone device. The application can generate one or more icons for accessing the application functionality, and can receive airflow data from the anemometer. The application can also apply one or more algorithms to the received airflow data to generate airflow information such as air velocity and air volume.

Another embodiment of the present invention can include an environmental sensor unit, and an electronic compass that are located within the wireless anemometer device. These components can function to generate additional airflow data which can allow the application to determine additional airflow information such as the direction of the anemometer device, the air temperature, humidity, pressure, dew point, wind chill, heat index, and/or apparent temperature.

Yet another embodiment of the present invention can also include the ability for the airflow balancing application to store and transmit airflow information to secondary devices utilizing the communicative abilities of the smartphone.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates one embodiment of a smartphone-operated wireless HVAC anemometer device and system that is useful for understanding the inventive concepts disclosed herein.

FIG. 2 is an exploded parts view of the wireless anemometer device of FIG. 1, in accordance with one embodiment of the invention.

FIG. 3 is a simplistic block diagram of the controller of the wireless anemometer device, in accordance with one embodiment of the invention.

FIG. 4 is a schematic diagram of the wireless anemometer device, in accordance with one embodiment of the invention.

FIG. 5 is a flow chart schematic of the airflow balancing application (“App”) of the smartphone-operated wireless HVAC anemometer system, in accordance with one embodiment of the invention.

FIG. 6 illustrates an exemplary display screen which can be generated by the airflow balancing application, in accordance with one embodiment of the invention.

FIG. 7 illustrates an exemplary display screen which can be generated by the airflow balancing application, in accordance with one embodiment of the invention.

FIG. 8A illustrates an exemplary display screen which can be generated by the airflow balancing application, in accordance with one embodiment of the invention.

FIG. 8B illustrates an exemplary display screen which can be generated by the airflow balancing application, in accordance with one embodiment of the invention.

FIG. 9A illustrates an exemplary display screen which can be generated by the airflow balancing application, in accordance with one embodiment of the invention.

FIG. 9B illustrates an exemplary display screen which can be generated by the airflow balancing application, in accordance with one embodiment of the invention.

FIG. 10 illustrates an exemplary display screen which can be generated by the airflow balancing application, in accordance with one embodiment of the invention.

FIG. 11 illustrates an exemplary display screen which can be generated by the airflow balancing application, in accordance with one embodiment of the invention.

FIG. 12 illustrates an exemplary display screen which can be generated by the airflow balancing application, in accordance with one embodiment of the invention.

FIG. 13 illustrates an exemplary display screen which can be generated by the airflow balancing application, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

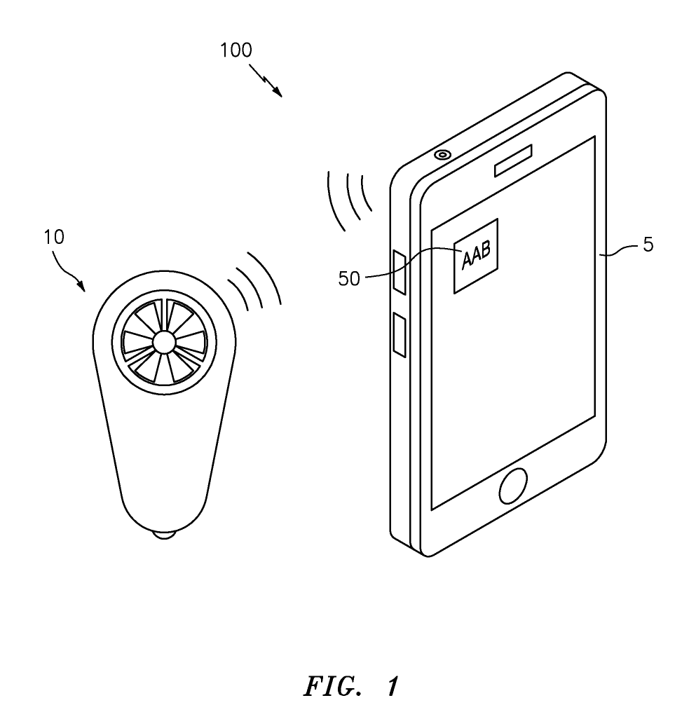

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

A smartphone-operated anemometer system 100 can function to allow a user to quickly and easily capture airflow data from the HVAC system of a building or other desirable location utilizing an anemometer device 10 that is physically coupled with a smartphone or other such device running an airflow balancing application 50. As such, the system 100 can utilize the processing power, storage and communicative abilities of the smartphone to accurately measure and/or calculate airflow information. In this regard, the system can utilize the smartphone to power the anemometer device, to receive data from the device, to apply complex calculations and algorithms to the received data, to provide onscreen user guidance, and to create and send reports containing the received and/or calculated information.

As described throughout this document, the term “airflow data” can include any form of information that can be captured by the below described anemometer device. Likewise, the term “airflow information” can include any data that is received or calculated from the airflow data that is supplied in whole, or in part by the below described anemometer device 10. Several nonlimiting examples of airflow information can include, for example: air velocity, air volume, temperature, humidity, pressure, dew point, wind chill, heat index, and/or apparent temperature.

In the below described examples, programming code for implementing the anemometer system can be presented in the form of a smartphone mobile application (i.e., App) which can be preloaded on a smartphone device, or downloaded and installed as an application after purchase of the smartphone device. Of course, the inventive concepts disclosed herein are not to be construed as limiting to a smartphone App, as virtually any type of instruction sets, in any form of programming language that can be executed on a processor enabled device are also contemplated.

Although described for use with a smartphone, this is for illustrative purposes only, as any type of processor enabled device that is capable of providing two way communication with a secondary device and/or a human operator can be utilized herein. Several nonlimiting examples include Bluetooth enabled phones, tablet computers, portable computers, PDAs, portable music devices (MP3 players), and wearable devices such as smartphone watches, for example. Accordingly, the device and/or method steps are not to be construed as limiting in any manner.

A user's smartphone or tablet device generally includes installed software adapted to generate an airflow balancing icon that is included with the airflow balancing application 50, and to display same on the display screen of the smartphone device. An actuating means is provided for actuating the airflow balancing icon through use of a touch sensitive smartphone or tablet screen, and/or a keypad, for example. Selecting the airflow balancing icon launches the system application and/or launches a linked web page through internet connectivity wherein the below described presentation screens are generated. Selecting the airflow balancing icon also activates the devices wireless communication unit such as a Bluetooth transceiver, for example.

FIGS. 1-10 illustrate various embodiments of a smartphone-operated wireless HVAC anemometer device and system that are useful for understanding the inventive concepts disclosed herein. As shown, in FIG. 1, the system 100 can include an anemometer device 10 that can be wirelessly connected to a smartphone 5 running an airflow balancing application 50.

In this regard, the anemometer device 10 can include, essentially, a main body 11, having an impeller assembly 20, that is in communication with an inductor 33, and a controller 30.

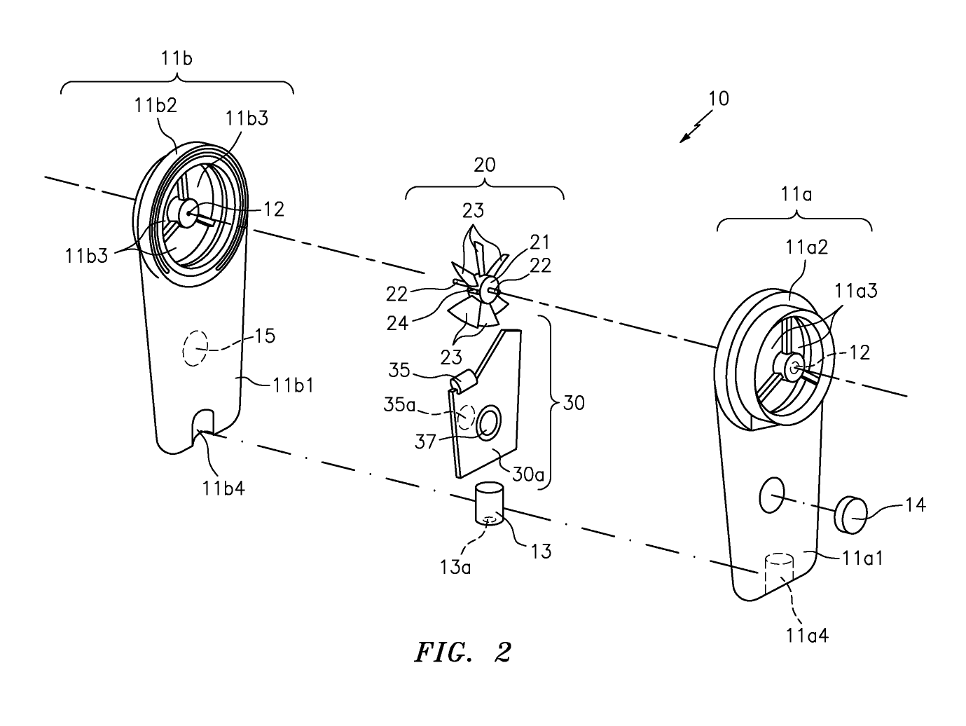

FIG. 2 is an exploded parts view of the device 10, in accordance with one embodiment. As shown, the main body 11 can be manufactured to include two complementary half sections 11a and 11b that are each preferably constructed from injection molded plastic. Each of the main body sections can include a lower portion 11a1 and 11b1, respectively forming a central cavity for receiving the below described controller and inductor. Each of the main body sections can also include a generally circular upper portion 11a2 and 11b2 for receiving the impeller assembly 20. In this regard, the upper portions can include any number of apertures 11a3 and 11b3, along with a pair of centrally located micro radial bearings 12 into which the axles of the impeller can be positioned. In this arrangement, the impeller can freely spin within the upper portions of the main body and can also be protected against direct impacts with foreign objects.

In one embodiment, a shaft connector 13 having an opening 13a with a plurality of threaded elements disposed therein can be provided. The shaft connector can function to engage complementary threaded elements of an industry standard camera mount, so as to allow the device 10 to be utilized in conjunction with an extension arm, camera tripod, or other such device. In the preferred embodiment, the shaft connector 13 can be secured via second cavity sections 11a4 and 11b4, along the bottom end of the main body. Of course, any number of other locations are also contemplated. In another embodiment, one of the main body sections 11b can also include a removable panel 14. The panel(s) can be located along the main body at a location that is adjacent to the device battery 38, so as to allow a user to easily replace the same. Likewise, the other main body section 11a can include a resilient surface area 15 that corresponds to the location of a button 35a for activating various features of the device described below.

Although described and illustrated with respect to a particular shape and/or construction material, this is for illustrative purposes only, as the main body, the shaft connector, and/or the panel(s) can take any number of different shapes and sizes, to suit any particular industry or use. Moreover, each of these components can be constructed from any number of different materials such as metal, various plastics, PVC and/or composites, for example utilizing known construction methodologies.

The impeller assembly 20 can include a central hub 21 having an elongated axle 22 extending therethrough, a plurality of angled blades 23 radiating outward therefrom, and a magnet 24 positioned thereon. The magnet 24 is preferably cylindrical in shape and is magnetized across its diameter. As will be described below, the magnet 24 will work in conjunction with the inductor 33 to generate airflow data. In the preferred embodiment, the impeller 20 can be constructed from injection molded plastic, and the axle 22 can be constructed from metal such as steel, for example. Of course, any number of other materials are also contemplated.

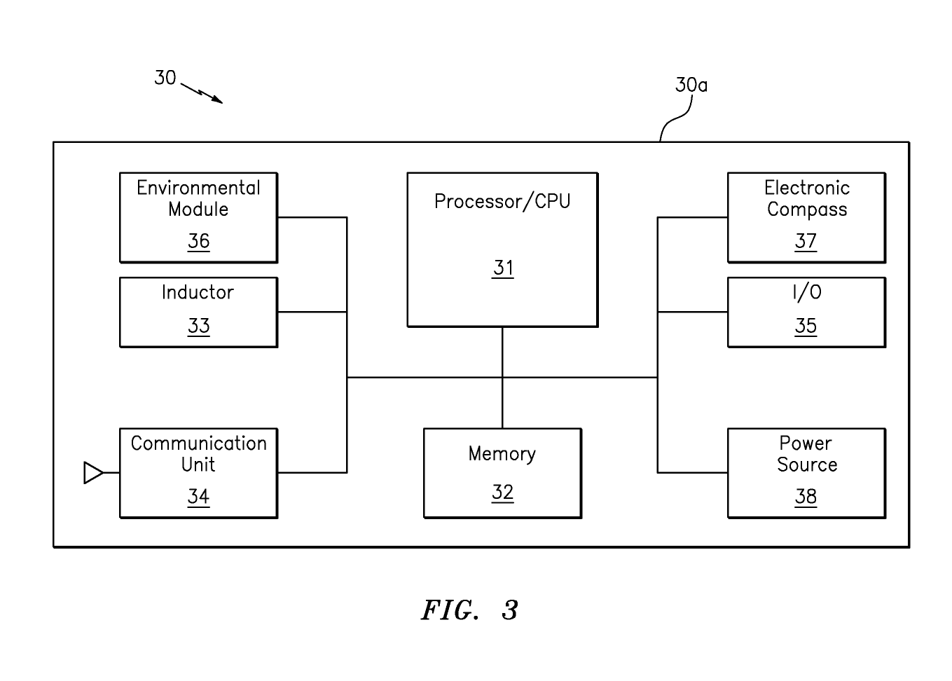

The controller 30 can communicate with the impeller assembly, and can transmit airflow data to a smartphone device. In this regard, FIG. 3 illustrates an exemplary block diagram of one embodiment of a suitable controller 30. As shown, the controller can include a processor 31 that is conventionally connected to a memory 32, an inductor 33, a communication unit 34, one or more input/output units 35, an environmental sensor unit 36, an electronic compass 37, and/or a power source 38.

Although illustrated as separate elements, those of skill in the art will recognize that one or more system components may be, or may include, one or more printed circuit boards (PCB) 30a, containing an integrated circuit or circuits for completing the activities described herein, and the CPU may be one or more integrated circuits having firmware for causing the circuitry to complete the activities described herein. Additionally, one or more of the controller elements may also be arranged as a completely separate element (such as the power source and/or the inductor, for example) that is/are communicatively linked to the processor.

The processor/CPU 31 can act to execute program code stored in the memory 32 in order to allow the device to perform the functionality described herein. Processors are extremely well known in the art, therefore no further description will be provided.

Memory 32 can act to store operating instructions in the form of program code for the processor 31 to execute. Although illustrated in FIG. 3 as a single component, memory 32 can include any number of individual local memory components. As used herein, local memory can refer to random access memory or other non-persistent memory device(s) generally used during actual execution of program code.

The inductor 33 can include a pick up coil or other such device that is in electrical communication with the processor, and that is placed in close proximity to the magnet 24 of the impeller assembly.

The communication unit 34 can include any number of devices capable of communicating with a smartphone or other externally located processor enabled device. In one preferred embodiment, the communication unit can include a wireless communication module that consists of a Bluetooth transceiver for communicating wirelessly with a smartphone running an App. However, any number of other known transmission and reception mechanisms and/or communication protocols can also be utilized herein, several nonlimiting examples include unique radio frequency transmitter and receivers, infrared (IR), RFID, and/or a network adapter functioning to communicate over a WAN, LAN or the internet via an internet service provider.

Although described above as performing wireless communication, other embodiments are also contemplated. In this regard, the communication unit can include, or can interface with, any number of physical communication devices capable of sending and receiving information with a smartphone. Several nonlimiting examples include USB ports and cables, micro USB ports and cables, and other such devices.

One or more input/output units 35, can function to accept user inputs and/or provide instructions to the processor. In one embodiment, the device 10 can include one or more resilient push buttons 35a which can individually or cumulatively initiate various programmatic functions of the device. Several nonlimiting examples of functionality which can be performed by the input/output unit includes the ability to switch the device between an ON and OFF operating state, initiate a sleep mode, and/or to pair the communication unit 34 with a smartphone or other such device.

The environmental sensor unit 36 can function to detect environmental conditions and report the same to the processor 31 for transmission to the App 50. In the preferred embodiment, the environmental sensor unit can include functionality to capture the temperature, humidity and/or pressure of the air flowing through the impeller. As such, the sensor unit 36 can preferably be positioned onto the PCB 30a at a location adjacent to the impeller assembly. Although described as a single device, the environmental sensor unit can include one or more different components that individually or cumulatively capture the above described information. For example, the unit 36 can include a solid state humidity module, a surface mount temperature sensor, and a board mount pressure sensor, for example.

The electronic compass 37 can function to allow the device 10 to automatically detect the magnetic north, in order to determine/calculate the direction of the device. This information can be provided to the processor 31 for transmission to the App 50. By providing an embedded compass, the device 10 can capture accurate information, independent of the location and/or direction of the user device 5. In this regard, the electronic compass 37 can preferably include a solid state magnetometer board. Of course, any number of other devices capable of performing similar functionality are also contemplated.

In one preferred embodiment, the power source 38 can include one or more coin cell batteries that are capable of providing the necessary power requirements to each element of the device 10. In one embodiment, the battery or batteries can be accessible via the removable cover(s) 14 located along the main body, in order to allow a user to easily access and replace the batteries when they are depleted. Of course, the invention is not limited to such a feature, as other embodiments are contemplated wherein one or more batteries are permanently located within the main body and can be rechargeable in nature via a charging port (not illustrated), or other such manner.

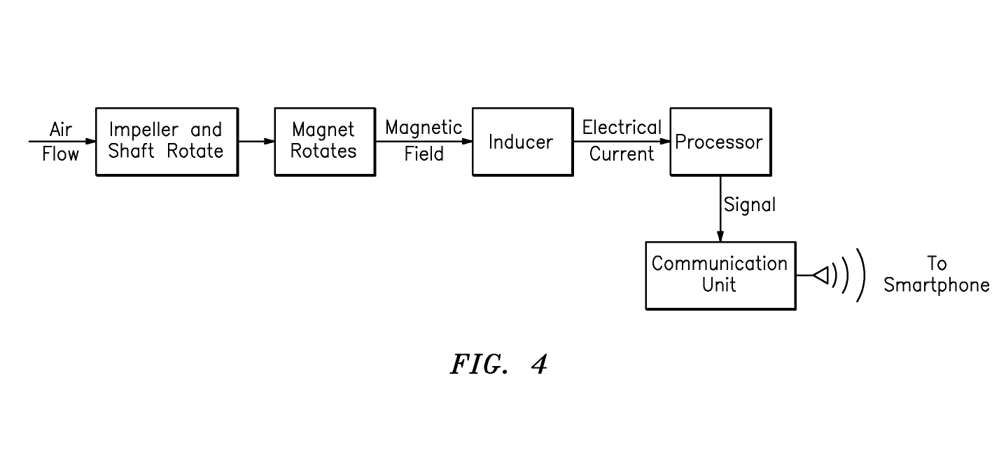

In operation, and as depicted schematically in FIG. 4, when the device 10 is placed near an HVAC duct, the air movement will cause the impeller blades 23 to rotate. As the magnet 24 is embedded along or within the hub 21 it will also rotate, thereby causing the magnetic field received by the inductor 33 to vary in magnitude. This induces an electrical current in the inductor 33 that is transmitted by electrical conductors to the processor 31. After receiving the information from the inductor, the processor can direct the communication unit 34 to transmit the captured airflow data to the smartphone app 50, wherein airflow information can be viewed and/or calculated.

As will be known to those of skill in the art, since the magnet rotates in relation to the speed of the air exiting or entering the HVAC duct, the variation in the magnetic field produced by the rotation of the magnet is indicative of the speed of the airflow. Furthermore, since the electrical current induced in the inductor is proportional to the variation in the magnetic field, the electrical current sent to the processor is indicative of the speed of the airflow. The induced current is proportional to the variation in the magnetic field.

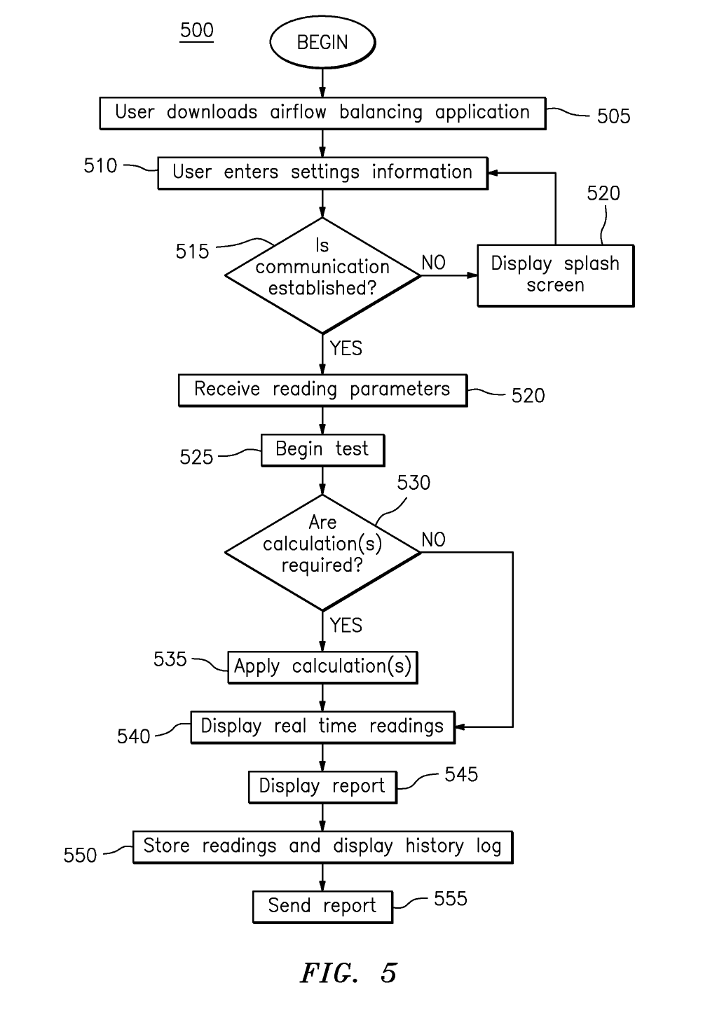

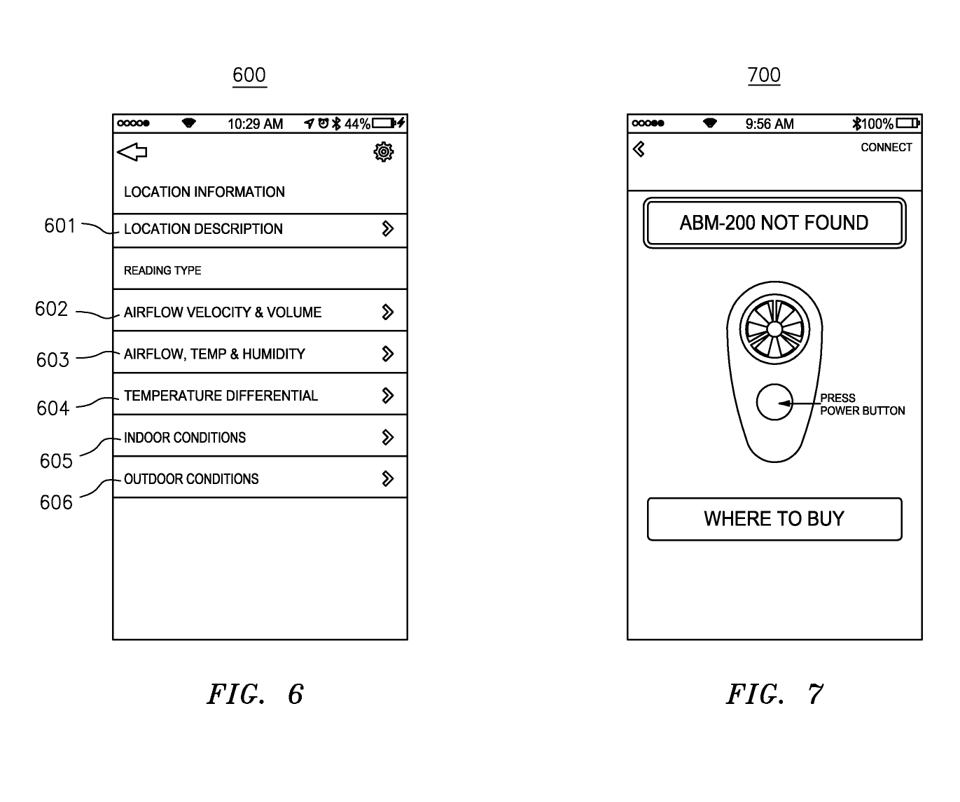

A method of using the smartphone-operated wireless HVAC anemometer system 100 will now be described with respect to FIG. 5. Moreover, several exemplary presentation screens which can be generated by the system are presented with respect to FIGS. 6-10. Although described below with respect to particular steps and screens, this is for illustrative purposes only, as the methodology described herein can be performed in a different order than shown, and the presentation screens can include any number of additional information and features.

FIG. 5 illustrates an exemplary flow chart 500 of the airflow balancing application system that is useful for understanding the inventive concepts disclosed herein. As shown, the method can begin at step 505, wherein the consumer/user can download and install the airflow balancing application 50 onto their smartphone device.

After the initial install and when the App is launched for the first time, the method can proceed to step 510 wherein a Settings screen can be generated by the system. The settings screen can provide and request information that will allow the user to capture airflow information with the system. In one embodiment, the settings screen can provide preliminary information to the user, such as safety information, operating instructions, local ordinances, and the like, before allowing the user to establish communication between the smartphone 5 and the anemometer 10. Additionally, the settings screen can allow the user to input various preferences.

FIG. 6 illustrates an exemplary Settings presentation screen 600 which can be generated by the application 50 to be displayed to a user on the smartphone device 5. As shown, the settings screen 600 can allow the user to input a particular location description 601, and can then provide any number of user selectable options for capturing and/or determining airflow information. As shown, several available options can include capturing Airflow Velocity & Volume 602, Airflow Temperature & Humidity 603, Temperature Differential 604, Indoor Conditions 605 and/or Outdoor Conditions 606. Although not specifically illustrated, the settings screen can also provide options for allowing a user to select preferred units of measurement, volume units, an email address to which history reports can be sent, and/or AK factor adjustments.

Once communication between the smartphone 5 and the device 10 has been established at step 515, such as through Bluetooth pairing, for example, the system can proceed to step 520 wherein the user can be presented with options for selecting the parameters of the reading about to be taken. If the App 50 is unable to detect the device, the system can generate a notification screen 700, such as that illustrated in FIG. 7, until the device and the App are linked.

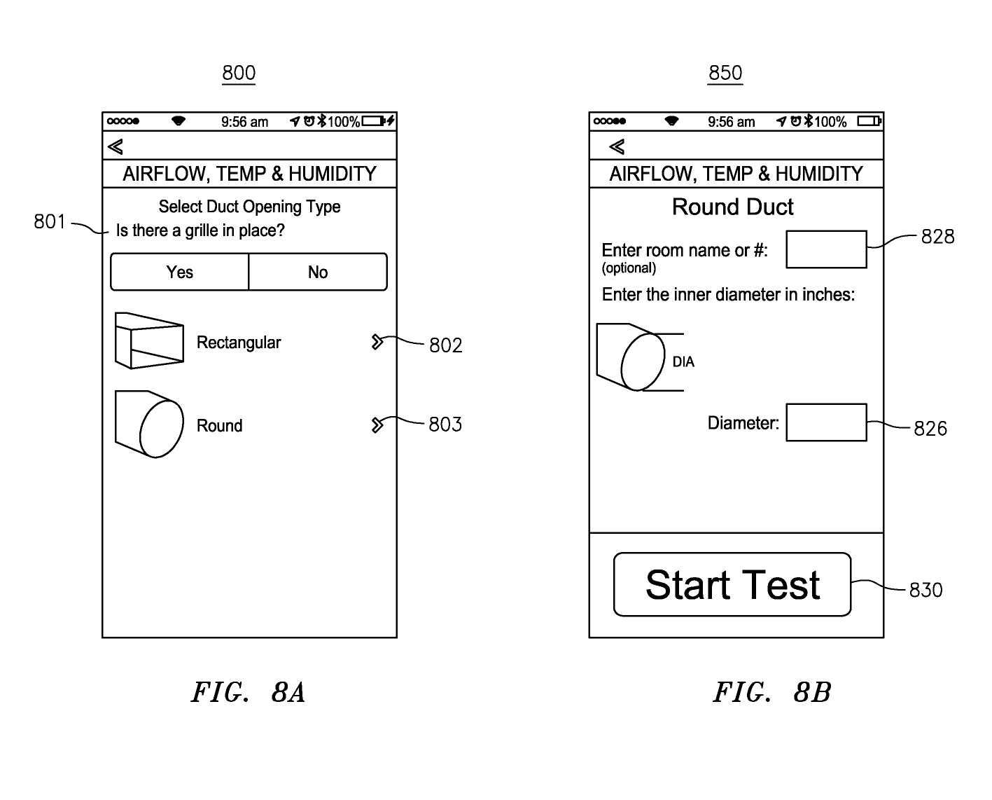

FIG. 8A illustrates an exemplary Duct Opening screen 800 generated by the application 50 to be displayed to a user on the smartphone device 5 at step 520. The screen can be presented in response to a user selecting option 603 above, wherein the user desires to identify the airflow, temperature and humidity.

As shown, the duct opening screen can include options for allowing a user to select whether the duct has a grille in place 801, and the shape of the duct opening such as rectangular 802, or round 803. Upon receiving this information, the system can generate a dimensions screen 850 (FIG. 8B), wherein the user can enter the diameter 826 of the duct (or the width and height if rectangular was selected). Additionally, the user can assign a unique name or identifier 828 for this duct, which can be included in the below described report. Once all requested information has been received, the user can start the test at step 525 by selecting the Start Test button 830.

At step 530, the device 10 can be placed near the duct so as to detect the wind movement as described above. Prior to, or during the testing period, the system can determine 530 if calculations are necessary to render the airflow information, based on the parameters selected by the user in step 520. If calculations are needed, the system can apply one or more algorithms and/or mathematical steps to the airflow data being received from the device 10, in order to calculate 536 the requested airflow information. In this regard, the Airflow balancing App 50 that is loaded onto the smartphone 5 can include and store within the smartphone memory any number of different mathematical equations, algorithms and/or process steps that are necessary to determine the requested airflow information. As such, the smartphone processor can be utilized to apply one or more stored equations to the airflow data from the wireless anemometer 10, and can display the same to the end user.

For example, if the parameters of step 525 indicate a rectangular grille, the system can apply the following formula:

W×H×LFM/144=CFM\if grille=yes,then CFM×0.90=net CFM

Likewise, if the parameters of step 525 indicate a round grille, the system can apply the following formula:

(DIA/2)²×3.14159×LFM/144=CFM if grille=yes,then CFM×0.90=net CFM

Of course, many other formulas and/or equations can also be applied such as values for compensating for the AK factor, and other such items based on the entered parameters and requested information.

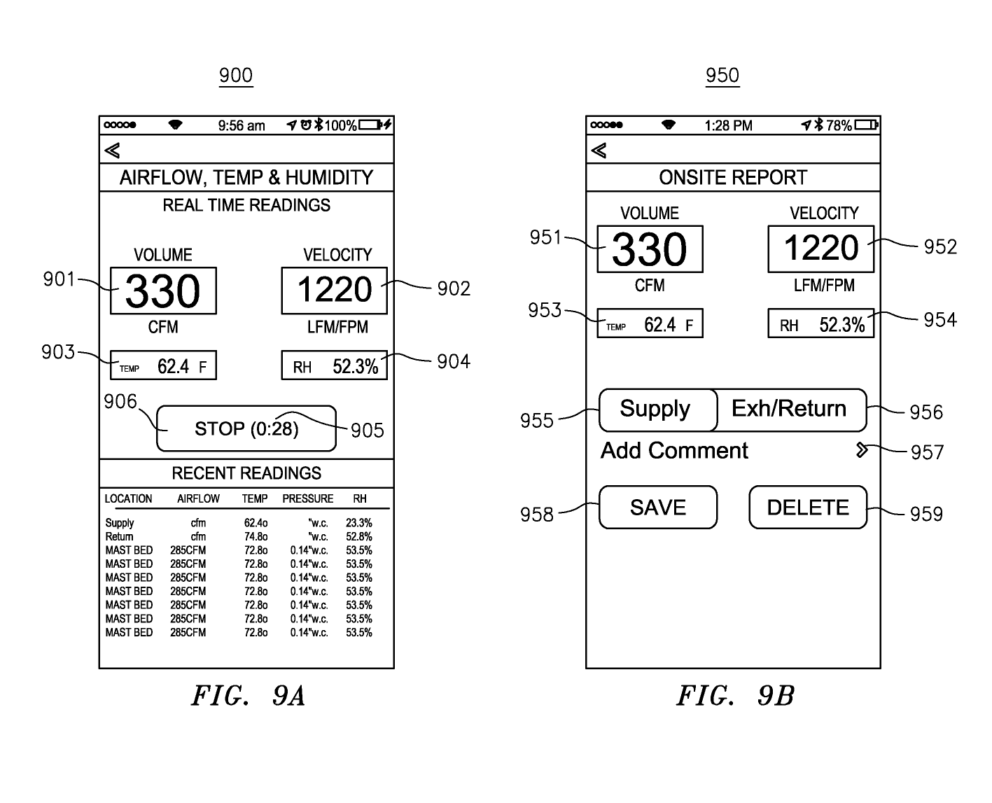

In either instance, during the test period, the system can display the real time readings to the user at step 540 via a presentation screen as shown in FIG. 9A. As shown, the readings screen 900 can include a digital presentation of the airflow as it is captured. This information can include, for example the airflow volume 901, the airflow velocity 902, the temperature 903 and the relative humidity 904. Each of these readings will be in the units selected by the user in step 510. In the preferred embodiment, the reading will last for 30 seconds, in order to account for any brief fluctuations or anomalies in airflow, however other periods of time can be specified. As such, the screen 900 can provide a timer 905 which can display the test time. A stop command 906 is provided wherein the user can terminate the test at any time.

Once the readings have been taken, the method can proceed to step 545 wherein the system can generate an Onsite Report. As shown in FIG. 9B, the Onsite Report screen 950 can include the total average the airflow volume 951, airflow velocity 952, temperature 953, and relative humidity 954 for the location identified at step 525. At this time, the user can specify whether the reading was taken from a supply 955 or return vent 956, and the user can enter any comments 957 which he or she would like included in the final report.

Once completed, the method can proceed to step 550, where the onsite report can be saved to the history log 958, or deleted 959.

As noted above, the system can function to generate airflow information for a variety of different circumstances and locations. As such, FIGS. 10-12 provide exemplary presentation screens for allowing a user to determine temperature differential, indoor conditions, and outdoor conditions, in response to the user selecting options 604, 605, and 606, respectively, in step 510.

As shown in FIG. 10, the system can also generate a temperature differential screen 1000, wherein the system can determine the temperature differential 1001, and the relative humidity differential 1002 between a supply vent 1003 and an exhaust vent 1004. This information can be transmitted to the App 50 wherein the processor of the user device 5 can calculate the differences. At this time, the information can be saved to the history log 1005, or deleted 1006.

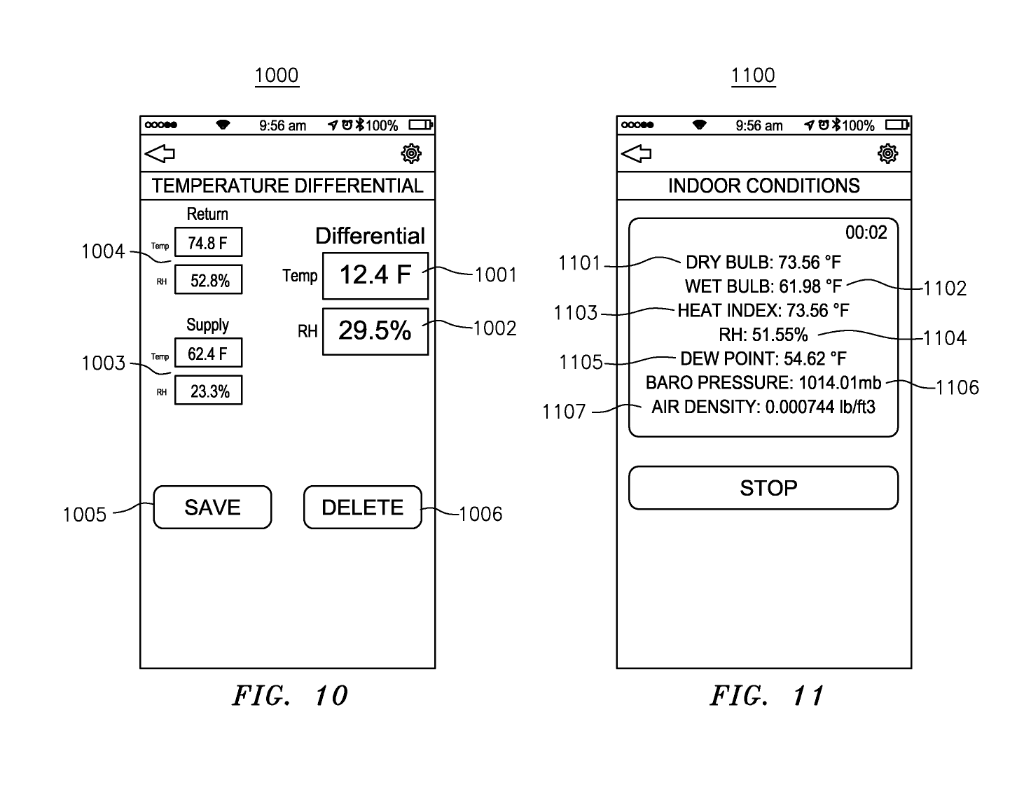

As shown in FIG. 11, the system can also generate an indoor conditions screen 1100, wherein the environmental sensor module can determine various factors such as a dry bulb temperature 1101, a wet bulb temperature 1102, the heat index 1103, the relative Humidity 1104, the dew point 1105, barometric pressure 1106, and/or the air density 1107.

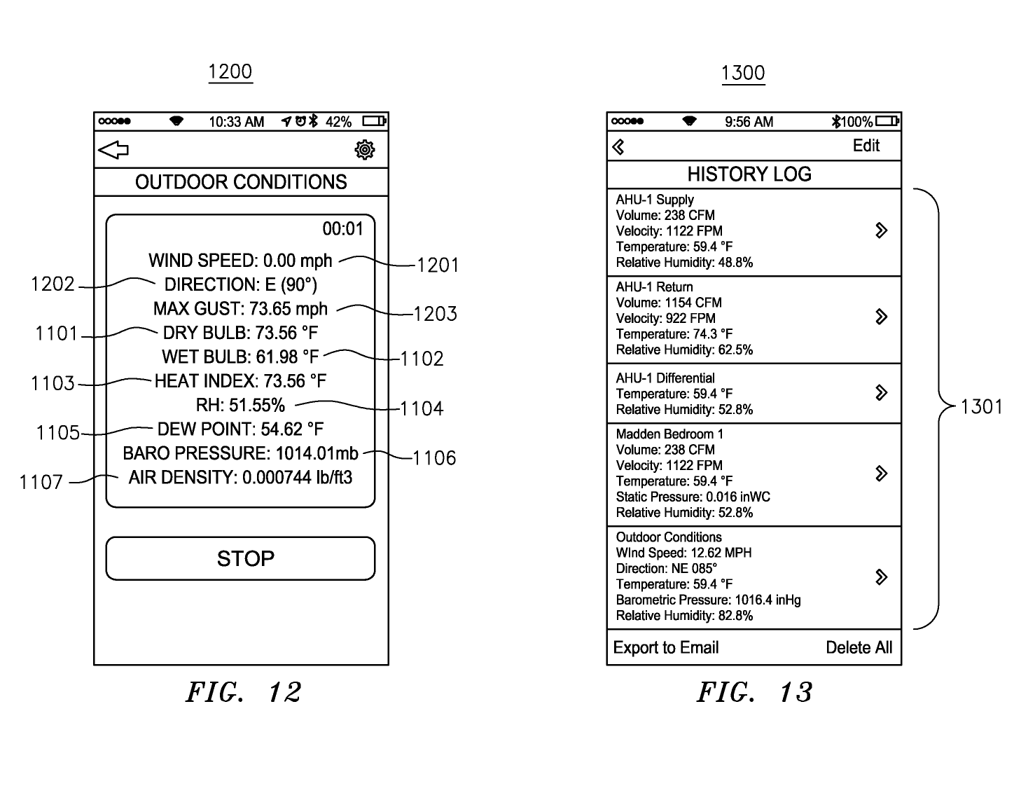

As shown in FIG. 12, the system can also be used to generate airflow information for uses other than HVAC applications. As shown, the system can also generate an outdoor conditions screen 1200, wherein the environmental sensor module can determine the above described dry bulb temperature 1101, a wet bulb temperature 1102, the heat index 1103, the relative Humidity 1104, the dew point 1105, barometric pressure 1106, and the air density 1107, along with other information such as the wind speed 1201, direction 1202 (utilizing the electronic compass) and any wind gusts 1203.

In either instance, FIG. 13 illustrates one embodiment of the History log 1300 which can be generated by the system. As shown, the log can include each of the readings 1301 taken by the device 10, as described above, and the same can be sorted based on the unique identifier 828.

Finally, the method can proceed to step 555 where the system can provide functionality for utilizing the communication abilities of the user device 5 to send a report containing individual readings and/or the History log by selecting the send history button 1005. In one embodiment, the report can automatically be transmitted as an HTML document to a contact address or other such location identified by the user at step 510. Of course, other embodiments are also contemplated wherein the user can select alternate and/or additional contacts, file types and/or transmission methods such as text messages, social media posts, encrypted/secure transmissions and the like, utilizing the smartphone components.

Although described and illustrated as displaying and calculating certain types of airflow information from the HVAC system of a building, those of skill in the art will recognize that the system 100 can be configured to display and calculate an unlimited amount of information from virtually any known air source, without undue experimentation, and without deviating from the scope and spirit of the inventive concepts disclosed herein.

Accordingly, the above described device and system provides users with a low cost alternative to stand alone anemometer devices, and utilizes the processing power and communicative ability of the users own smartphone to calculate, store and transmit airflow information in a novel manner.

As described herein, one or more elements of the smartphone-operated wireless HVAC anemometer device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's smartphone, partly on the user's smartphone, as a stand-alone software package, partly on the user's smartphone and partly on a remote computer or entirely on the remote computer or server. In the latter scenario, the remote computer may be connected to the user's smartphone through any type of network, including a cellular network connection, a local area network (LAN) or a wide area network (WAN), or the connection may be made to an external computer (for example, through the Internet using an Internet Service Provider).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An airflow anemometer system, comprising:
an airflow balancing application that includes machine readable instructions for execution on a smartphone device having a processor, a memory, internet connectivity, and a display screen, said application functioning to
generate an airflow balancing icon on the display screen, and
calculate and display airflow information; and
an anemometer device that includes
a main body having an external surface that defines an internal cavity,
an impeller assembly that is positioned within the main body, and
a controller that is in communication with the impeller assembly, said controller functioning to generate airflow data, and to transmit the generated airflow data to the airflow balancing application.

2. The system of claim 1, wherein the impeller assembly comprises:
a central hub having an elongated axle extending therethrough;
a plurality of angled blades that radiate outward from the central hub; and
a magnet that is positioned along the central hub.

3. The system of claim 2, wherein said magnet includes a cylindrical shaped member that is magnetized across a diameter thereof, and
said magnet including a length that extends across a length of the impeller hub.

4. The system of claim 1, wherein the controller comprises:
a memory;
an inductor that is positioned adjacent to the impeller assembly;
a wireless communication unit that functions to communicate wirelessly with the airflow balancing application;
an input/output unit;
a power source; and
a processor that is in communication with, and controls an operation of each of the power source, the input/output unit, the wireless communication module, the inductor, and the memory.

5. The system of claim 4, further comprising:
an environmental sensor unit that is in communication with the processor, said unit functioning to capture at least one of a temperature, a humidity and an air pressure.

6. The system of claim 4, further comprising:
an electronic compass that is in communication with the processor, said compass functioning to determine a direction of the anemometer device.

7. The system of claim 4, wherein the wireless communication module includes, at least one of a unique radio frequency transmitter and receiver, an infrared transmitter and receiver, and a wireless network adapter.

8. The system of claim 4, wherein the wireless communication module includes a Bluetooth transceiver.

9. The system of claim 4, wherein the input/output unit includes one or more resilient push buttons that function to receive user inputs and communicate the same to the processor.

10. The system of claim 1, further comprising:
a shaft connector that is disposed along a bottom surface of the main body, said shaft connector including an opening having a plurality of threaded elements disposed therein, and
said shaft connector being configured to engage an industry standard camera mount.

11. The system of claim 1, wherein the airflow balancing application further includes functionality for storing one or more algorithms within the memory of the smartphone device.

12. The system of claim 11, wherein the airflow balancing application further includes functionality for applying one or more of the stored algorithms to the airflow data to generate the airflow information.

13. The system of claim 12, wherein the airflow information includes at least one of an air velocity, an air volume, a temperature, a humidity, a pressure, a dew point, a wind chill, a heat index, and an apparent temperature.

14. The system of claim 12, wherein the airflow information includes each of an air velocity, an air volume, a temperature, a humidity, a pressure, a dew point, a wind chill, a heat index, and an apparent temperature.

15. The system of claim 1, wherein the airflow balancing application further includes functionality for applying a different algorithm based on a shape of an HVAC duct.

16. The system of claim 1, wherein the airflow balancing application further includes functionality for creating a history log screen displaying the airflow information.

17. The system of claim 16, wherein the airflow balancing application further includes functionality for instructing the smartphone to transmit the history log to a secondary device.

18. The system of claim 1, wherein the airflow balancing application further includes functionality for determining a temperature differential between a supply vent and an exhaust vent.

19. The system of claim 1, wherein the airflow balancing application further includes functionality for determining a relative humidity differential between a supply vent and an exhaust vent.
